(19) United States
(12) Patent Application Publication
(10) Pub. No.: US 2004/0153241 A1
(43) Pub. Date: Aug. 5, 2004

(54) Navigation system

(75) Inventor: Takamitsu Suzuki, Okazaki-city (JP)

Correspondence Address: POSZ & BETHARDS, PLC, 11250 ROGER BACON DRIVE, SUITE 10, RESTON, VA, 20190, US

(73) Assignee: DENSO CORPORATION

(21) Appl. No.: 10/729,956

(22) Filed: Dec. 9, 2003

(30) Foreign Application Priority Data
Feb. 5, 2003 (JP) 2003-28437

(51) Int. Cl. G01C 21/34

(52) U.S. Cl. 701/211; 701/209; 340/995.19

(57) ABSTRACT

In a navigation device, matching is executed between road shape data read from a map data storage medium and road shape data included in guidance route data received from a server. Road data relevant to that of the guidance route data is thereby designated from the road data stored in the map data storage medium. Connection relation of the road data between the map data storage medium and the guidance route is then established. This results in eliminating a problem that it is difficult for the navigation device to indicate a correct present position when the navigation device moves along a route different from the guidance route.

### CROSS REFERENCE TO RELATED APPLICATIONS

This application is based on and incorporates herein by reference Japanese Patent Application No. 2003-28437 filed on Feb. 5, 2003.

### FIELD OF THE INVENTION

The present invention relates to, of navigation devices executing various guidance processing, a navigation device that executes route guidance through obtaining guidance route data via a network.

### BACKGROUND OF THE INVENTION

In a navigation device, road data should be updated as reflecting actual road states changing due to new road opening or road widening. The road data is conventionally updated through replacing or rewriting a fixed storage medium such as a CD-ROM, a DVD-ROM, or a hard disk. This requires periodical updating that is bothersome. When updating is not periodically executed, the road data in the fixed storage medium becomes unreliable.

To solve this problem, for instance, JP-A-H5-216400 discloses a method. In this method, a changing date of map information is stored along with map information. Each time map information is used, it is determined whether the present time is earlier than the stored changing date. When it is determined to be earlier, the map information is directly used without any change. By contrast, when it is determined to be not earlier, change information is reflected on the map information. The map information on which the change information is reflected is thereby used after the changing date.

In addition, the latest road data is always stored in a server within a network so that a navigation device can receive the latest road data from the server generally via wireless communications such as a cell phone. However, this method involves limited data transmission amount due to a low data rate of the cell phone or not negligible communications cost paid by a user depending on a chosen accounting contract. Therefore, it is considered that the server is provided with the following. The server does not send the entire latest road data. The server receives information of a starting point and a destination. Based on the received information, a guidance route is computed along with considering the latest traffic information. Only the computed guidance route is then sent to the navigation device.

Here, the sent guidance route is simply superposed on the road data stored in the fixed storage medium. If the superposed guidance route and the road data in the fixed storage medium have no inconsistence with each other, a basic function such as a present position indicating function or a route guidance function can be smoothly executed without any problem.

However, no connection relation pertinent to data exists between the road data stored in the fixed storage medium and the road data constituting the guidance route. For instance, suppose that a navigation device moves along a route different from the guidance route during the execution of the route guidance function. Here, the present position of the navigation device indicated on a display is hardly shifted from the guidance route due to the map matching function. The present position is not thereby correctly indicated. No connection relation between data of the fixed storage medium and the data constituting the guidance route means that the guidance route is a single road without being connected with other roads. Therefore, an enlarged guidance cannot be indicated for an intersection where turning right/left is required. To solve this problem, the connection relation needs to be established between the road data of the fixed storage medium and the road data constituting the guidance route.

Here, if a fixed number assigning method, where assigning numbers are constant even after updating the fixed storage medium, is used in node and link numbers stored in the fixed storage medium, the connection relation can be easily established by making the data of the guidance route follow the fixed number assigning method.

However, the road data stored in the fixed storage medium does not typically follow the fixed number assigning method, but a variable number assigning method, where the node and link numbers are newly assigned each time the updating is executed. It is because the variable number assigning method can indicate a series of roads as a unit or decrease a total data amount without necessity for reserving extra numbers for future use. When the variable number assigning method is used, the connection relation cannot be established due to inconsistency in the node and link numbers. Accordingly, the difficulty has been not avoided in indicating the present position when the navigation device moves in a route different from the guidance route or in indicating the enlarged guidance map of the intersection.

### SUMMARY OF THE INVENTION

It is an object of the present invention to provide a navigation device capable of executing kind and proper route guidance by establishing connection relation on data between road data in a storage medium and road data included in guidance route data from a server.

To achieve the above and other objects, a navigation device is provided with the following. Road data including road shape data is read from a storage medium. Guidance route data including road shape data is received from a server via a communications network. Here, road data relevant to the guidance route data is designated from the read road data through executing matching between the received road shape data and the read road shape data. The route guidance is executed after reflecting the guidance route data on the road data relevant to the guidance route data.

In this structure, for instance, a map matching technology is used, so that road data relevant to the guidance route data can be designated even when road data stored in the storage medium does not thoroughly correspond to the guidance route data received from the server. The route guidance can be thereby executed after reflecting the guidance route data received from the server on the road data read from the storage medium. Namely, for instance, as long as the server has the latest version of the road data, the route guidance can be always executed according to the latest road states.

### BRIEF DESCRIPTION OF THE DRAWINGS

The above and other objects, features, and advantages of the present invention will become more apparent from the following detailed description made with reference to the accompanying drawings. In the drawings:

FIG. 1 is a schematic block diagram showing an overall structure of a navigation device according to an embodiment of the present invention;

FIG. 2 is a flowchart diagram explaining route guidance processing according to the embodiment;

FIG. 3 is a flowchart diagram explaining map data reading processing according to the embodiment;

FIG. 4 is a flowchart diagram explaining map data merging processing according to the embodiment; and

FIGS. 5A, 5B, 6A, 6B are diagrams showing instances of merging map data according to the embodiment.

### DETAILED DESCRIPTION OF THE PREFERRED EMBODIMENTS

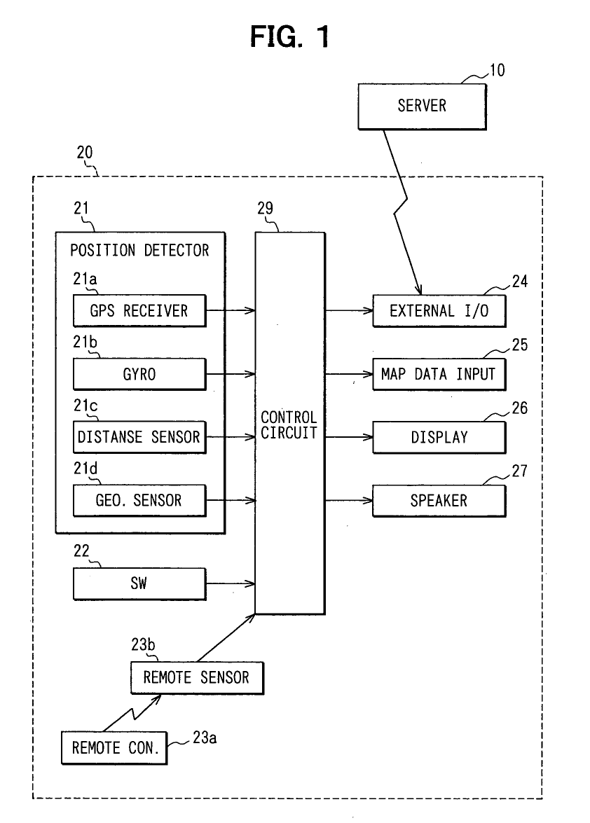

An overall structure of a navigation device 20 according to an embodiment of the present invention is shown in FIG. 1 along with a server 10 also according to an embodiment of the present invention.

The navigation device 20 mounted in a vehicle is equipped with: a position detector 21 for outputting signals for detecting a vehicle's present position or the like; a manipulation switch group 22 for inputting various instructions by a user; a remote controller 23a being physically separated from the navigation device 20 for inputting various instructions similar to the manipulation switch group 22; a controller sensor 23b for receiving signals from the remote controller 23a; an external information I/O unit 24 for communicating with the server 10; a map data input unit 25 for inputting information from a storage medium having map data or various information; a display 26 for displaying a map or various information; a speaker 27 for outputting various guidance voices or the like; and a control circuit 29.

The control circuit 29 is for executing various processing according to the inputted signals from the position detector 21, the manipulation switch group 22, the controller sensor 22b, the external information I/O unit 24, and the map data input unit 25. The control circuit 29 is then for controlling the external information I/O unit 24, the display 26, and the speaker 27.

The position detector 21 includes: a GPS (Global Positioning System) receiver 21a for detecting the present position of the vehicle based on radio waves from GPS satellites; a gyroscope 21b for outputting signals for detecting magnitude of rotation movement acting on the vehicle; a distance sensor 21c for outputting signals for detecting a traveling distance by using acceleration forward and backward of the vehicle; and a geomagnetic sensor 21d for outputting signals for detecting an advancing direction by using geomagnetism. Each sensor 21a to 21d has a different characteristic and detection accuracy, so that high position detection accuracy is obtained by adjusting the respective errors through combining signals from some of the sensors 21a to 21d.

The manipulation switch group 22 includes touch panel switches that are integrated with the display 26 or mechanical switches disposed around the display 26. The touch panel and the display 26 are integrated by being laminated. The touch panel can be any one of a pressure-sensitive type, an electromagnetic induction type, an electric capacitance type, or a combination of the preceding types.

The external information I/O unit 24 communicates with the server 10 via an antenna (not shown).

The map data input unit 25 is for inputting from the storage medium (not shown) being stored with the map data such as node numbers, link numbers, road shape data, road width data, road type data, road numbers, road regulation data, land form data, mark data, intersection data, and facility data. The storage medium for the map data commonly uses not only a CD-ROM or a DVD due to its data amount, but also a magnetic storage device such as a hard disk, a memory card, or the like.

The display 26 of a color display can be a liquid crystal display (LCD), an organic EL display, or a CRT. The display 26 displays a road map with overlapping it with additional data such as: an own vehicle mark that is designated based on signals outputted by the position detector 21 and the map data inputted from the map data input unit 25: a guidance route to a destination; a name; a land mark; a facility mark; or the like. The display 26 can also display guidance for a facility.

The speaker 27 is, e.g., for outputting, via speech, guidance of a facility inputted from the map data input unit 25, various guidance, or traffic information received through the external information I/O unit 24.

The control circuit 29 is mainly constructed of a common micro-computer including a CPU, a ROM, a RAM, an I/O, and a bus line intermediating between the preceding components. Based on programs stored in the ROM or RAM, the control circuit 29 executes: computing a present position as coordinates and an advancing direction by using various signals from the position detector 21; displaying on the display 26 a map surrounding the present position read from the map data input unit 25 or the like; and processing for route guidance according to position data stored in the map data input unit 25; or the like.

The server 10 includes a communications function for communicating with the navigation device 10, a road data storing function for storing the latest road data, and a route guidance function for computing a guidance route based on a starting point, a pass point, a destination, and traffic information.

(1) Route Guidance Processing

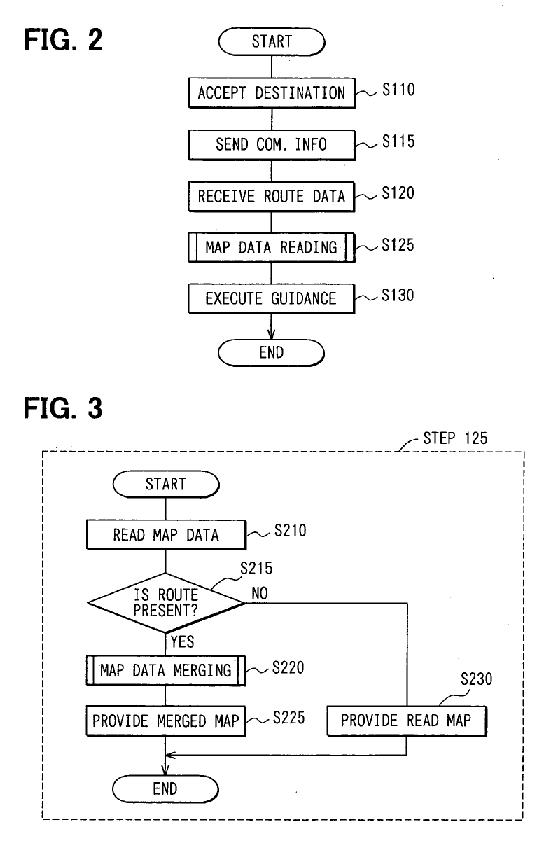

In the next place, route guidance processing will be explained with reference to FIG. 2. The processing is started by manipulating the manipulation switch group 22 or the remote controller 23a by a user.

As the processing is started, a message requesting that a user inputs information relating to a destination point and a pass point is displayed on the display 26 for accepting the point inputted by the user at Step 110. The user's input can be done by designating the point on a map displayed on the display 26, inputting a name or the like of the point, or designating a previously registered point.

At Step 115, guidance route computing information is sent to the server 10 via the external information I/O unit 24. The guidance route computing information relates to information that includes the destination and the pass point inputted by the user, a present position of the vehicle, and a computing condition such as whether a toll road is preferably used.

As the server 10 receives the guidance route computing information, the server 10 computes guidance route data based on the guidance route computing information, road data, and traffic information. The server 10 then sends the computed guidance route data to the navigation device 20. The guidance route data includes node numbers, link numbers, road shape data, or the like. Here, the road shape data included in the guidance route data and the former-mentioned road data of the map data stored in the storage medium can be any data that can indicate a road shape such as shape point data. The shape point data is a plurality of coordinates indicating road shapes by using absolute coordinates of World Geodetic System (WGS).

The navigation device 20 receives the guidance route data from the server 10 via the external information I/O unit 24 to store it in the RAM within the control circuit 29 at Step 120. Map data reading processing, which will be explained later, is then executed at Step 125.

Route guidance is finally executed based on the map data read by the map data reading processing. At Step 130, on the display 16, a guidance route and a mark indicating the present position of the vehicle are overlapped on a map surrounding the present position of the vehicle. In addition, as the vehicle approaches an intersection where the vehicle is to turn right or left, an enlarged image of the intersection is displayed on the display 26. Audio information indicating to which direction the vehicle turns is also outputted via the speaker 27. The route guidance continues till the vehicle arrives at the destination.

(2) Map Data Reading Processing

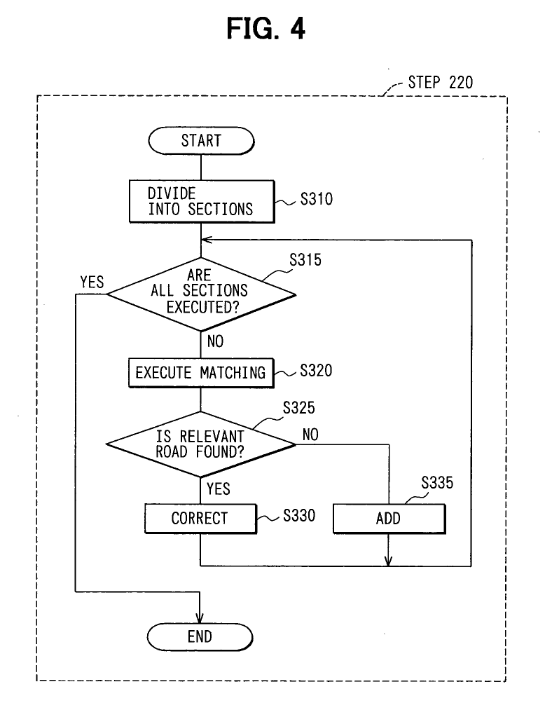

The map data reading processing executed by the control circuit 29 will be explained with reference to FIG. 3. This processing is started when the user manipulates the manipulation switch group 22 or the remote controller 23a so as to set a destination or the like or to consult a map.

As the processing is started, necessary map data is read from the storage medium via the map data input unit 25 at Step 210. If the processing is started within the route guidance processing, the necessary map data means map data necessary for the route guidance processing. Otherwise, if the processing is started for displaying a map on the display 26, the necessary map data means map data necessary for displaying the map.

At Step 215, it is determined whether a guidance route is present in an area of the read map data. The guidance route used for the determination is based on the guidance route data stored in the RAM within the control circuit 29. Here, when the guidance route data is not present in the RAM, the guidance route data is unconditionally determined to be not present. When the guidance route is determined to be present in the area of the read map data (YES at Step 215), map data merging processing, which will be explained later, is executed at Step 220.

At Step 225, the merged map data is provided to the route guidance processing that derived the map data reading processing itself, as the map data merging processing is completed. Furthermore, at Step 225, the merged map data is provided to the display 26 as map data for displaying a map. The map data reading processing is then terminated.

By contrast, when the guidance route is determined to be not present in the area of the read map data (NO at Step 215), the processing proceeds to Step 230. Here, the map data read from the storage medium is directly (without any change) provided to the route guidance processing that derived the map data reading processing itself. The map data reading processing is then terminated.

(3) Map Data Merging Processing

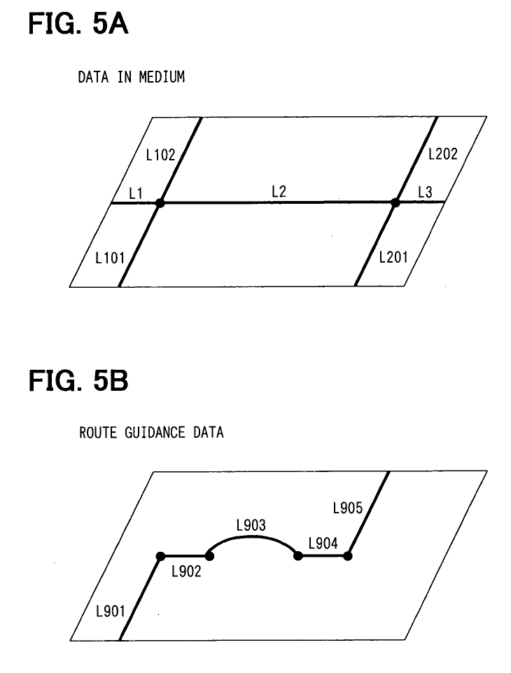

The map data merging processing executed by the control circuit 29 will be explained with reference to FIG. 4. This processing is started within the map data reading processing.

As the processing is started, the guidance route is divided into sections at Step 310. The sections can be generated based on a distance or the number of nodes. Otherwise, each of the sections can correspond to a reading unit of the map data.

At Step 315, it is determined whether matching processing which will be explained later is executed to all the sections. When the matching processing is determined to be executed to all the sections (YES at Step 315), the map data merging processing is then terminated.

When the matching processing is determined to be not executed to all the sections (NO at Step 315), the processing proceeds to Step 320. Here, the matching processing is executed to a section, to which the matching processing is not completed, by using the map data read from the storage medium by using the road shape data and road attribute data constituting the guidance route data received from the server 10. An instance of the matching processing will be explained later.

At Step 325, it is determined whether a road relevant to the section is found through the matching processing. When a relevant road is determined to be found (YES at Step 325), the relevant road data of the map data read from the storage medium is corrected by using the guidance route data of the relevant section at Step 330. The processing then returns to Step 315. The correction at Step 330 can be executed only when the shape data or road attribute data is different between the guidance route data and the relevant road data of the read map data. Otherwise, the correction can be executed irrespective of the shape data or the road attribute data.

By contrast, when a relevant road is determined to be not found (NO at Step 325), the guidance route data of the relevant section is added to the map data read from the storage medium at Step 335. The processing then returns to Step 315.

The map data merging processing will be explained in detail by using an instance as below. At first, here, “matching” uses a map matching technology that is commonly adopted in designating a present position of a navigation device. In the map matching technology, the present position estimated by a position detector such as a GPS, a speed sensor, and a gyroscope is logically reflected on a road map displayed on a display. In this embodiment, this map matching technology is used for designating a road relevant to the guidance route from the road data stored in the storage medium. Therefore, processing unit for the map matching technology can be also used for designating the road relevant to the guidance route.

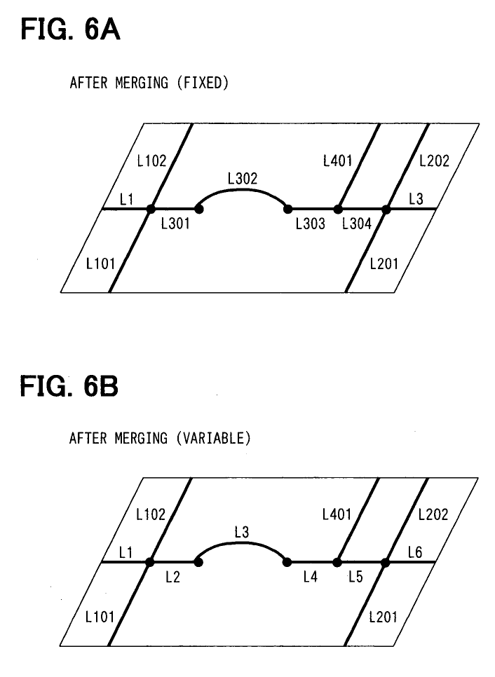

In FIG. 5A, a schematic road is indicated by using the map data stored in the storage medium. A road constituted by links L1 to L3 is intersected with a road constituted by links L101, L102 and a road constituted by links L201, L202. Suppose that the guidance route data including a schematic road shown in FIG. 5B is received from the server 10. Here, the guidance route is formed of links L901 to L905.

Between the map data indicating the road shown in FIG. 5A and the guidance route data indicating the road shown in FIG. 5B, the matching processing is executed as follows. At first, the link L101 in FIG. 5A and the link L901 in FIG. 5B exist in the almost same location, so that both links L101, L901 are determined to be matching to each other. Although the link L903 in FIG. 5B is a little differently located from the link L2 in FIG. 5A, the link L903 is determined to be matching to the link L2 in this instance. In addition, the link L902 to L904 is determined to be matching to the link L2. The link L905 is determined to be not matching to any link in FIG. 5A.

In the above determination, distances between the shape points of the links of the guidance route and that of the links of the matching candidate links are computed. When the link of the guidance route has plural matching candidate links, the plural matching candidate links are estimated by being computed. Among the candidate links, a candidate link having the minimum total of the distances is designated. When the designated candidate link has the total of not more than a given value, the designated candidate link is determined to be matching. When the candidate is only a single link, it is determined whether the total of the distances of the link is not more than the given value. Similarly, when the link has the total of not more than the given value, the link is determined to be matching.

As a result, new map data shown in FIGS. 6A, 6B are generated after merging. FIG. 6A shows a case where a fixed number assigning method is used, while FIG. 6B shows a case where a variable number assigning method. In FIG. 6A, the link L2 in FIG. 5A prior to merging is re-defined as links L301 to L304. Here, of the links L301 to L304, the link L302 shown in FIG. 6A is different from the link L2 shown in FIG. 5A with having a curvature according to the guidance route data received from the server 10. The link L905 that is shown in FIG. 5B and determined to be not matching to any link is defined as a link L401 shown in FIG. 6A.

By contrast, assigning numbers in FIG. 6B are different from that in FIG. 6A. In FIG. 6B, the link L3 in FIG. 5A prior to merging is re-defined as a link L6. The link L2 in FIG. 5A prior to merging is re-defined as links L2 to L5. The link L905 that is shown in FIG. 5B and determined to be not matching to any link is defined as a link L401 shown in FIG. 6A.

As shown in FIG. 6B, the assigning numbers are serially assigned in the variable number assigning method, so that plural links can be designated by designating the link numbers of the both ends. This enables the plural links to be indicated by using only a small data amount.

As explained above, the navigation device 20 of the embodiment executes the guidance route processing, the map data reading processing, and map data merging processing. Through executing the processings, the navigation device 20 designates road data relevant to the guidance route data received from the server 10 by the matching processing among the road data stored in the storage medium. The navigation device 20 then establishes the connection relation on data between the road data and the guidance route data. Here, establishing the connection relation is executed by reflecting the guidance route data on the road data stored in the storage medium. Namely, establishing the connection relation is executed by replacing a code system of the guidance route data with that of the road data stored in the storage medium, by generating new road data by merging the guidance route data into the road data stored in the storage medium, or by other methods.

Incidentally, the road attribute data includes information relating to roads as follows: road kinds such as national roads, prefectural roads, or highways; road numbers such as No. 1 or No. 11; road regulations such as one-way traffic. Suppose that the server 10 is provided as sending road attribute data along with the guidance route data. Here, when the navigation device 10 is provided with a function of map matching additionally using the road attribute data, the matching processing can be more accurately executed in the embodiment of the present invention. An accuracy degree can be thereby enhanced in designating a road relevant to the guidance route data among the road data stored in the storage medium.

Accordingly, this results in solving problems developed in a conventional navigation device. One problem is, for instance, that a correct present position is not indicated when a navigation device moves along a route different from a guidance route. Another is, for instance, that an enlarged image of an intersection where a vehicle is to turn right or left cannot be shown. In the matching processing, a map matching technology is used, so that a road relevant to the guidance route data can be designated irrespective of a number assigning method of the fixed or variable. Furthermore, even when road data stored in the storage medium does not thoroughly correspond to the guidance route data received from the server, the relevant road can be designated. In detail, the relevant road can be designated even when no correspondence in the road shape data exists. Furthermore, the relevant road can be designated when no correspondence exists in the road attribute data and nevertheless correspondence exists in the road shape data.

The navigation device 20 executes the route guidance by correcting road data of the designated road by using the guidance route data. As long as the server 10 has the latest version of the road data, the navigation device 20 can thereby execute the route guidance according to the latest road states.

The navigation device 20 executes the route guidance by adding the guidance route data to the road data read from the storage medium. The addition is executed when a road relevant to the guidance route is not found or, for instance, when a route is only partially relevant to a portion up to an intermediate point of the guidance route, or when no route is partially relevant to a portion of the guidance route. For instance, even when guidance route data including a newly opened road is received from the server 10 and no relevant road is matching to it, the navigation device 20 can properly execute the route guidance.

(Others)

(1) When a storage medium is a rewritable medium such as a hard disk, road data can be corrected or include new road data based on map data merged in the above map data merging processing. In this structure, processing accuracy can be enhanced not only in the route guidance but also in other processings using the road data.

(2) In the above embodiment, the navigation device 20 sends a destination, a pass point, or the like to the server 10, and the server 20 computes based on the sent information a guidance route. However, the server 10 can be designed as computing the guidance route by independently determining the destination, the pass point, or the like. Here, the same effect as in the above embodiment can be also obtained. This method can be used in a delivery and collection service such as a door-to-door parcel delivery.

(3) The sever 10 can be a personal computer possessed by a user. Namely, the user computes a guidance route by using the personal computer at home. The computed guidance route can be sent to a navigation device 20 via short range wireless communications or a cable. By using a medium such as a memory card the computed guidance route can be shifted to the navigation device 20. Here, the same effect as in the above embodiment can be also obtained. Furthermore, user's usability can be enhanced.

(4) A program that executes the processings in the embodiment can be stored in a computer readable medium such as a flexible disk, an optical magnetic disk, a CD-ROM, a hard disk, a ROM, a RAM, or the like. The program stored in any one of the preceding media can be used by being downloaded into a computer when needed. Otherwise, the program can be downloaded into a computer via a communications network.

It will be obvious to those skilled in the art that various changes may be made in the above-described embodiments of the present invention. However, the scope of the present invention should be determined by the following claims.

What is claimed is:

1. A navigation device comprising:
a storage medium managing unit for reading road data including road shape data from a storage medium;
a communications unit for receiving guidance route data including road shape data from a server via a communications network; and
a route guidance executing unit for executing route guidance by using the road data read by the storage medium managing unit and the guidance route data received by the communications unit,
wherein the route guidance executing unit designates road data relevant to the guidance route data from the road data read by the storage medium managing unit through executing matching between the road shape data received by the communications unit and the road shape data read by the storage medium managing unit, and
wherein the route guidance executing unit then executes the route guidance after reflecting the guidance route data on the road data relevant to the guidance route data.

2. The navigation device of claim 1,
wherein the communications unit receives the guidance route data including road attribute data, and
wherein the route guidance executing unit executes the matching by also using the road attribute data.

3. The navigation device of claim 1,
wherein the route guidance executing unit executes the route guidance after correcting the designated road data relevant to the guidance route data by using the guidance route data.

4. The navigation device of claim 1,
wherein the storage medium managing unit can execute rewriting on the storage medium, and
wherein the route guidance executing unit makes the storage medium managing unit correct, by using the guidance route data, the designated road data that is relevant to the guidance route data and is stored in the storage medium.

5. The navigation device of claim 1,
wherein, when no road data relevant to the guidance route data is designated from the road data read by the storage medium managing unit through executing matching, the route guidance executing unit executes the route guidance by adding the guidance route data to the road data read by the storage medium managing unit.

6. The navigation device of claim 1,
wherein, when no road data relevant to the guidance route data is designated from the road data read by the storage medium managing unit through executing matching, the route guidance executing unit makes the storage medium managing unit add the guidance route data to the storage medium.

7. A server comprising:
a computing unit for computing guidance route data for a guidance route based on a starting point and a destination; and
a communications unit for sending the computed guidance route data to a navigation device via a communications network,
wherein the computed guidance route data includes road shape data indicating a road shape.

8. The server of claim 7,
wherein the computed guidance route data includes road attribute data indicating a road attribute.

9. A computer program product including a computer readable medium used for executing route guidance in a navigation system having:
a storage medium managing unit for reading road data including road shape data from a storage medium; and
a communications unit for receiving guidance route data from a server via a communications network,
the computer program product comprising:
instructions for reading the road data including the road shape data from the storage medium;
instructions for receiving the guidance route data including road shape data from the server;
instructions for designating road data relevant to the guidance route data from the road data read from the storage medium through executing matching between the road shape data received from the server and the road shape data read from the storage medium; and
instructions for executing the route guidance after reflecting the guidance route data on the road data relevant to the guidance route data.
